(19) United States
(12) Patent Application Publication
(10) Pub. No.: US 2024/0257497 A1
(43) Pub. Date: Aug. 1, 2024

(54) MULTI-FRAME ANALYSIS FOR CLASSIFYING TARGET FEATURES IN MEDICAL VIDEOS

(71) Applicant: Verily Life Sciences LLC, South San Francisco, CA (US)

(72) Inventors: Roman Goldenberg, Haifa (IL); Ehud Rivlin, Haifa (IL); Amir Livne, Lohamei Hagetaot (IL); Israel Or Weinstein, Tel Aviv (IL)

(21) Appl. No.: 18/424,021

(22) Filed: Jan. 26, 2024

Related U.S. Application Data
(60) Provisional application No. 63/482,473, filed on Jan. 31, 2023.

(51) Int. Cl. G06V 10/764; G06V 10/82

(52) U.S. Cl. CPC G06V 10/764; G06V 10/82; G06V 2201/032

(57) ABSTRACT

Methods, systems, and devices for classifying a target feature in a medical video are presented herein. Some methods may include the steps of: receiving a plurality of frames of the medical video, where the plurality of frames include the target feature; generating, by a first pretrained machine learning model, an embedding vector for each frame of the plurality of frames, each embedding vector having a predetermined number of values; and generating, by a second pretrained machine learning model, a classification of the target feature using the plurality of embedding vectors, where the second pretrained machine learning model analyzes the plurality of embedding vectors jointly.

### CROSS-REFERENCE TO RELATED APPLICATIONS

The present applications claims the benefit of and priority to, U.S. Provisional Patent Application No. 63/482,473, filed Jan. 31, 2023, the entirety of which is incorporated by reference herein.

### TECHNICAL FIELD

The present disclosure relates generally to using deep learning models to classify target features in the medical videos.

### BACKGROUND

Detecting and removing polyps in the colon is one of the most effective methods of preventing colon cancer. During a colonoscopy procedure, a physician will scan the colon for polyps. Upon finding a polyp, the physician must visually decide whether the polyp is at risk of becoming cancerous and should be removed. Certain types of polyps, including adenomas, have the potential to become cancer over time if allowed to grow while other types are unlikely to become cancer. Thus, correctly classifying these polyps is key to treating patients and preventing colon cancer.

By leveraging the power of artificial intelligence (AI), physicians may be able to identify and classify polyps more easily and accurately. AI is a powerful tool because it can analyze large amounts of data to learn how to make accurate predictions. However, to date, AI-driven algorithms have yet to meaningfully improve the ability of physicians to classify polyps. Therefore, improved AI-driven algorithms are needed to yield more accurate and useful classifications of polyps.

### SUMMARY

Methods of classifying a target feature in a medical video by one or more computer systems are presented herein. The one or more computer systems may include a first pretrained machine learning model and a second pretrained learning model. Some methods may include the steps of receiving a plurality of frames of the medical video, where the plurality of frames includes the target feature; generating, by the first pretrained machine learning model, an embedding vector for each frame of the plurality of frames, each embedding vector having a predetermined number of values; and generating, by the second pretrained machine learning model, a classification of the target feature using the plurality of embedding vectors, where the second pretrained machine learning model analyzes the plurality of embedding vectors jointly.

In some embodiments, the first pretrained learning model may include a convolutional neural network and the second pretrained machine learning model may include a transformer. In some embodiments, the classification may include a score in a range of 0 to 1. In some embodiments, the classification may include one of: positive, negative, or uncertain. In some embodiments, the classification includes a textual representation. In some embodiments, the first pretrained machine learning model and the second pretrained machine learning model may be jointly trained. In some embodiments, the first pretrained machine learning model and the second pretrained machine learning model may be trained separately. In some embodiments, the medical video may be collected during a colonoscopy procedure using an endoscope and the target feature may be a polyp. In some embodiments, the classification may include one of: adenomatous and non-adenomatous. In some embodiments, the second pretrained machine learning model may analyze the plurality of embedding vectors without classifying each embedding vector individually.

Systems for classifying a target feature in a medical video are described herein. In some embodiments, the systems may include an input interface configured to receive a medical video, and a memory configured to store a plurality of processor-executable instructions. The memory may include an embedder based on a first pretrained machine learning model and a classifier based on a second pretrained machine learning model. The processor may be configured to execute the plurality of processor-executable instruction to perform operations including: receiving a plurality of frames of the medical video, where the plurality of frames includes the target feature; generating, with the embedder, an embedding vector for each frame of the plurality of frames, each embedding vector having a predetermined number of values; and generating, with the classifier, a classification of the target feature using the plurality of embedding vectors, where the classifier analyzes the plurality of embedding vectors jointly.

In some embodiments, the first pretrained machine learning model may include a convolutional neural network and the second pretrained machine learning model may include a transformer. In some embodiments, the classification may include a score in a range of 0 to 1. In some embodiments, the classification may include one of: positive, negative, or uncertain. In some embodiments, the classification may include a textual representation.

Non-transitory processor-readable storage mediums storing a plurality of processor-executable instructions for classifying a target feature in a medical video are described. The instructions may be executed by a processor to perform operations comprising: receiving a plurality of frames of the medical video, where the plurality of frames includes the target feature; generating, by a first pretrained machine learning model, an embedding vector for each frame of the plurality of frames, each embedding vector having a predetermined number of values; and generating, by a second pretrained machine learning model, a classification of the target feature using the plurality of embedding vectors, where the second pretrained machine learning model analyzes the plurality of embedding vectors jointly.

In some embodiments, the first pretrained machine learning model may include a convolutional neural network and the second pretrained machine learning model may comprise a transformer. In some embodiments, the classification may include a score in a range of 0 to 1. In some embodiments, the classification may include one of: positive, negative, or uncertain. In some embodiments, the classification may include a textual representation.

### BRIEF DESCRIPTION OF THE DRAWINGS

Illustrative embodiments of the present disclosure will be described with reference to the accompanying drawings, of which:

FIG. 1 is a schematic diagram illustrating a computer system for implementing a target feature detector and a joint classification model, according to some aspects of the present disclosure.

FIG. 2 is a simplified diagram illustrating an example embodiment of a process, according to some aspects of the present disclosure.

FIG. 3 is a simplified diagram illustrating an example transformer architecture, according to some aspects of the present disclosure.

FIG. 4 is a simplified diagram illustrating an example multi-head attention model, according to some aspects of the present disclosure.

FIG. 5 is a simplified diagram illustrating an example of scaled dot-product attention, according to some aspects of the present disclosure.

FIG. 6 is a block diagram of a system for implementing one or more methods, according to some aspects of the present disclosure.

FIG. 7 is block diagram illustrating an example display, according to some aspects of the present disclosure.

FIG. 8 is a flow diagram illustrating an example method of training a joint classification model, according to some aspects of the present disclosure.

FIG. 9 is a flow diagram illustrating an example method of operating a target feature detector and joint classification model during the inference stage, according to some aspects of the present disclosure.

FIG. 10 is a graph of the Area Under the Receiver Operating Characteristic Curve (ROC AUC or AUC) versus the number of frames (or sequence length) for various models, according to some aspects of the present disclosure.

FIG. 11 is a graph of the positive probability value (PPV) versus the negative probability value (NPV) for various models, according to some aspects of the present disclosure.

FIG. 12 is a chart illustrating the classifications generated by various models for several series of frames, according to some aspects of the present disclosure.

### DETAILED DESCRIPTION

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

As used herein, the term “network” may comprise any hardware or software-based framework that includes any artificial intelligence network or system, neural network or system and/or any training or learning models implemented thereon or therewith.

As used herein, the term “model” may comprise hardware or software-based framework that performs one or more functions. In some embodiments, the model may be implemented on one or more neural networks.

Many scientists, physicians, programmers and others have been working on harnessing the power of artificial intelligence (AI) to quickly and accurately diagnose diseases. AI has been used in a variety of different diagnostic applications including, for example, detecting the presence of polyps in colonoscopy videos. Some of the most promising ways of diagnosing diseases from medical videos include using a machine learning (ML) and, in particular, neural networks (NN). By inputting hundreds or thousands of frames of a target feature, ML programs can develop methods, equations, and/or patterns for determining how to classify the target feature in future frames. For example, if a ML program is fed thousands of frames where a physician has already classified the polyp, the ML program can use this labeled training data to learn what each type of polyp looks like and how to identify the types of polyps in future colonoscopy videos.

The present disclosure generally relates to improved methods, systems, and devices for classifying target features in frames of a medical video. In some embodiments, a target feature detector may be used to detect the target features in a medical video and identify a collection of frames in a time interval that includes each target feature. A joint classification model, including an embedder and a classifier, may then receive the frames of medical video and classify the target feature therein. The embedder may generate an embedding vector for each frame received by the joint classification model. The embedding vectors may be a computer-readable vector or matrix representing the frame. The classifier may then use the embedding vectors to generate a classification of the target feature. Preferably, the classifier may analyze all frames jointly and generate a single classification for all frames.

By jointly analyzing the frames, the classifier can leverage information in multiple frames to more accurately understand the target feature shown in the frames. For instance, when comparing all frames, there may be one or more frames that do not provide a good view or a high-quality picture of the target feature and in some cases may not show the target feature at all. Compared to other models which classify each frame individually and aggregate the individual classifications, the joint classification model is better able to recognize and give less weight to these low-quality frames or outliers. Therefore, the joint classification model may more accurately classify the target features than other classification models currently in use.

These descriptions are provided for example purposes only and should not be considered to limit the scope of the invention described herein. Certain features may be added, removed, or modified without departing from the spirit of the claimed subject matter.

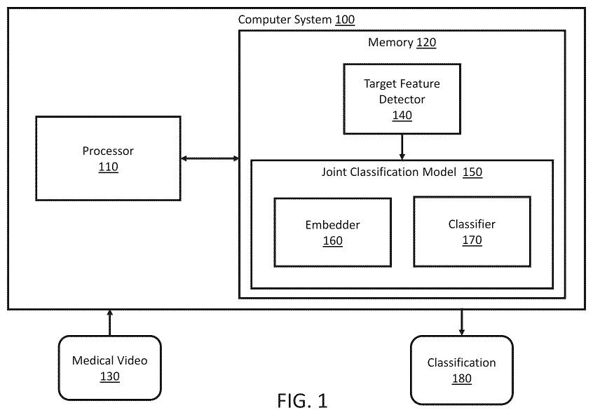

FIG. 1 is a schematic diagram illustrating a computer system 100 for implementing a target feature detector 140 and a joint classification model 150, according to some embodiments of the present disclosure. The computer system 100 includes a processor 110 coupled to a memory 120. Although the computing device 100 is shown with only one processor 110, it is understood that processor 110 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in the computing device 100. The computing device 100 may be implemented as a stand-alone subsystem, as a board added to a computing device, and/or as a virtual machine. The memory 120 may be used to store software executed by computing device 100 and/or one or more data structures used during operation of computing device 100. The memory 120 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor (e.g., the processor 110) or computer is adapted to read. In the present embodiments, for example, the memory 120 includes instructions suitable for training and/or using an image-to-image model 130 and/or a masking model 140 described herein.

The processor 110 and/or the memory 120 may be arranged in any suitable physical arrangement. In some embodiments, the processor 110 and/or the memory 120 are implemented on the same board, in the same package (e.g., system-in-package), on the same chip (e.g., system-on-chip), and/or the like. In some embodiments, the processor 110 and/or the memory 120 include distributed, virtualized, and/or containerized computing resources. Consistent with such embodiments, the processor 110 and/or the memory 120 may be located in one or more data centers and/or cloud computing facilities.

In some examples, the memory 120 may include non-transitory, tangible, machine readable media that includes executable code that when run by one or more processors (e.g., the processor 110) may cause the one or more processors to perform the methods described in further detail herein. For example, as shown, the memory 120 includes instructions for a target feature detector 140 and a joint classification model 150 that may be used to implement and/or emulate the systems and models, and/or to implement any of the methods described further herein. In some embodiments, the target feature detector 140 may receive a medical video 130 and detect target features in one or more frames of the medical video 130. In some embodiments, the target feature detector 140 identifies frames having a target feature and also identifies portions of the frames having the target feature. The joint classification model 150 may receive frames that include the detected target feature from the target feature detector 140. The joint classification model 150 may include an embedder 160 and a classifier 170. The embedder 160 may receive the frames of the detected target feature and generate an embedding vector for each frame, such that each frame has an associated embedding vector in one-to-one correspondence. The classifier 170 may then analyze the embedding vectors to classify the target feature and output the classification 180.

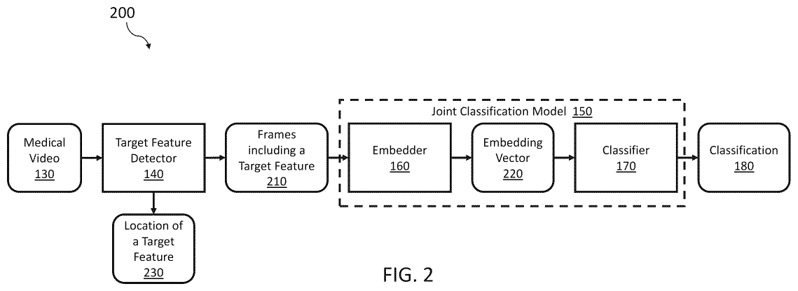

FIG. 2 is a simplified diagram illustrating an example embodiment of a process 200, according to one or more embodiments described herein. In the present embodiments, the process 200 describes aspects of using a target feature detector 140 and a joint classification model 150 incorporated in a computing device 100 for detecting and classifying target features of a medical video 130. In the present disclosure, the medical video 130 may be a colonoscopy video collected using an endoscope. However, it is contemplated that the medical video 130 could be any other type of medical video including, for example, video captured during other endoscopic procedures, ultrasound procedures, magnetic resonance imaging (MRI) procedures, or any other medical procedure. The target feature detected in the medical videos 130 may be specific to that video. For example, the target feature may be a polyp in a colonoscopy video. In other examples, the target feature may be a cancerous tumor, a stenosis, or any other suitable target feature.

In the present embodiments, the medical video 130 is input into the target feature detector 140. The target feature detector 140 may be configured to analyze the medical video 130 to detect target features. The target feature detector 140 may output frames 210 of the medical video 130 including one or more target features to the joint classification model 150. In addition to outputting the frames 210, the target feature detector 140 may also output a location of the target feature 230 to memory 120 or to a display. The embedder 160 may receive the frames 210 and generate embedding vectors 220 for each frame 210. The classifier 170 may then receive the embedding vectors 220 from the embedder 160 and analyze the embedding vectors 220 to classify the target feature. The classifier 170 may then output the classification 180.

The joint classification model 150 may include both the embedder 160 and the classifier 170 such that the models are jointly trained. However, the embedder 160 and classifier 170 may not be a joint classification model 150 and may instead be trained individually. In some embodiments, the embedder 160 may be jointly trained with the target feature detector 140. In some embodiments, the medical video 130 may be input into the embedder 160 before it is input into the target feature detector 140. The embedder 160 may then generate embedding vectors 220 for each frame of the medical video 130. The target feature detector 140 may then receive embedding vectors 220 and detect target features therein. In these cases, the classifier 170 may receive embedding vectors 220 that include the target feature from the target feature detector 140.

The target feature detector 140 may be implemented in any suitable way. In some embodiments, the target feature detector 140 may include a machine learning (ML) model and, in particular, may include a neural network (NN) model. For example, the target feature detector 140 may be an ML or NN based object detector. In some embodiments, the NN based target feature detector may be a two stage, proposal-driven mechanism such as a region-based convolutional neural network (R-CNN) framework. In some embodiments, the target feature detector 140 may use a RetinaNet architecture, as described in, for example, Lin et al., Focal Loss for Dense Object Detection, arXiv: 1708.02002 (Feb. 7, 2018) or in U.S. Patent Publication No. 2021/0225511, the entirety of which are incorporated herein by reference.

The target feature detector 140 may output the location of the target features in any appropriate way. For example, the target feature detector 140 may output the location of the target feature. The location of the target feature may include coordinates. In some cases, the location of the target feature may be bounded by a box, circle or other object surrounding or highlighting the target features in the medical video 130. The bounding box surrounding or highlighting the target feature is then combined with the medical video 130 such that, when displayed, the bounding box is displayed around target features in the medical video 130.

Additionally, the target feature detector 140 may output frames 210 of the medical video 130 including the target feature. The frames 210 may include any number of frames. In some embodiments, the frames 210 including the target feature may be the total number of frames in the medical video 130. In other embodiments, the frames 210 including the target feature may include less than the total number of frames in the medical video 130. For example, the frames 210 including the target feature may include any number of frames in a range of 1 to 200. In particular embodiments, the frames 210 including the target feature may include 1, 5, 10, 15, 20, 25, 30, 35, 40, 45, or 50 frames.

The frames 210 including a target feature may be smaller than the frames of the medical video 130. In some cases, the frames 210 including the target feature may be the portion of the frames of the medical video that are within a bounding box surrounding the target feature. In other cases, the frames 210 including the target feature may be the same size as the frames of the medical video 130. In these cases, the joint classification detector 150 may only analyze the portion of the frames within the bounding box.

The embedder 160 receives the frames 210 including the target feature and generates an embedding vector 220 for each frame 210. The embedding vector 220 may be a representation of the frame 210 that is computer readable. The embedder 160 may include an ML model such as a NN model. In some embodiments, the embedder 160 may use a convolutional NN (CNN).

The size of the embedding vectors 220 generated by the embedder 160 may be predetermined. The size of the embedding 220 may be determined in any suitable way. For example, the size may be determined through a hyper parameter search, which includes training several models, each with a different size, and choosing the size that produces the best outcomes. In other cases, the size of the embedding vector may be chosen based on other sizes known in the art that produce good outcomes. There may be a tradeoff when it comes to determining the size of the embedding vectors. As the vector size increases, the overall accuracy of the classification model is expected to increase. However, with vectors of a larger size, the models will also require more computing power and, thus, more time and cost. Therefore, the size that yields the best outcome may be a vector that is large enough to capture the necessary details for making accurate classifications while being small enough to minimize the computing power required. In some embodiments, the size of the vector may include 128 values.

The classifier 170 may receive the embedding vectors 220 from the embedder 160. The classifier 170 may analyze each frame 210 individually. In this case, the classifier 170 generates a classification for each frame 210 then aggregates all of the classifications to generate an overall classification 180 for the frames. However, in some embodiments, the classifier 170 may jointly analyze all of the frames 210 including the target feature to generate a single classification 180 for the frames 210. Analyzing multiple frames 210 jointly may be preferable to individually analyzing each frame 210 because when processing multiple frames 210 jointly leverages mutual information among the frames. Frames that are noisy outliers or are low-quality or include non-discriminative views of the target feature may generate an inaccurate classification (also known as a characterization) of the target feature. Thus, by jointly analyzing the frames 210, frames with a low-quality rendering of the target feature (or with no target feature shown) can be compared to other frames with a better rendering of the target feature. The frames with a better rendering of the target feature can be given a higher weight and frames with a low-quality rendering of the target feature can be given a lower weight. On the contrary, when each frame is analyzed individually and the classifications are aggregated, the low-quality frames may be given an equal weight to the high-quality frames. Thus, this may generate a less accurate overall classification 180. Therefore, analyzing all frames 210 jointly may generate more accurate classifications 180 than analyzing each frame 210 individually.

The classifier 170 may include an ML model such as a NN model. In some embodiments, the classifier 170 may include an attention model or a transformer. The transformer may be implemented in any suitable way. In some embodiments, the classifier 170 includes the self-attention based transformer as described in Vaswani et al., Attention is All You Need, arXiv: 1706.03762 (Dec. 6, 2017) or Dosovitskiy et al., An Image is Worth 16×16 Words: Transformers for Image Recognition at Scale, arXiv: 2010.11929 (Jun. 3, 2021), the entirety of which are incorporated herein by reference.

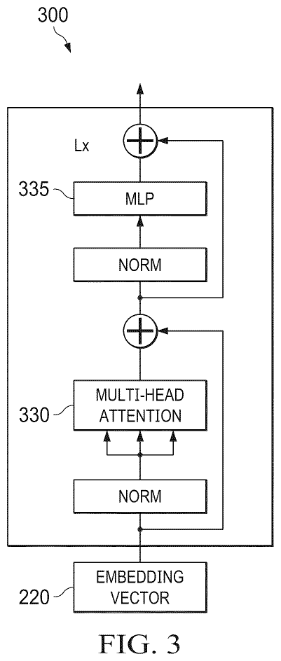

FIG. 3 is a simplified diagram illustrating an example transformer 300 architecture, according to one or more embodiments described herein. The transformer 300 includes multiple layers and sublayers, that analyze the embedding vectors 220 to generate a classification 180 of the target feature in the frames 210. The transformer 300 may map a sequence of symbol representations (x₁, . . . , xₙ) to a sequence of continuous representations z =(z₁, . . . , zₙ). In some cases, each symbol representation x may be the embedding vector 220 for the current frame xᵢ or multiple embedding vectors 220 from the current and past frames (x₁, . . . , xᵢ). By processing multiple embedding vectors (corresponding to multiple frames) in parallel, the transformer 300 is able to leverage mutual information among frames. Then, the continuous representations may be mapped to an output that may represent a score reflecting the likelihood or probability of a polyp classification, such as whether a polyp is adenomatous or non-adenomatous, as described in more detail below. Each step of the transformer 300 may be auto-regressive such that the previously generated symbols for a frame are received as an input for generating symbols for the next frame. In some aspects, the transformer 300 may also be referred to as a transformer encoder in recognition that it is an encoder portion of some transformer architectures.

The transformer 300 may include any appropriate number of layers L. For example, the transformer 300 may include 2, 4, 6, 8, or 10 layers L. Each layer L may include two sublayers. The first sublayer 330 of the encoder layer L may be a multi-head self-attention mechanism, as described in more detail below. The second sublayer 335 of the encoder layer N may be a multilayer perceptron (MLP) such as a simple, position-wise fully connected feed-forward network, as described in more detail below. There may be a residual connection around each of the sublayers 330, 335 followed by layer normalization. In some embodiments, the transformer 300 may have an MLP head that receives the output from the layers L. The input to the transformer 300 may be the embedding vector 220 for the current frame i or multiple embedding vectors from the current and past frames (x₁, . . . , xᵢ).

The output of each sublayer 330, 335 may produce outputs of the same dimension d_{model} . In some cases, embedding layers may be used before the transformer 300. The output of the embedding layers may be the same dimension d _{model} as the outputs of the sublayers 330, 335. In some cases, this dimension d_{model} may be 512.

The fully connected feed-forward network in sublayers 335, 350 may be applied to each position separately and identically. In some embodiments, the feed-forward network may include two linear transformations with a ReLU activation between the linear transformations. The linear transformations may be the same across different positions, but may use different parameters from layer to layer.

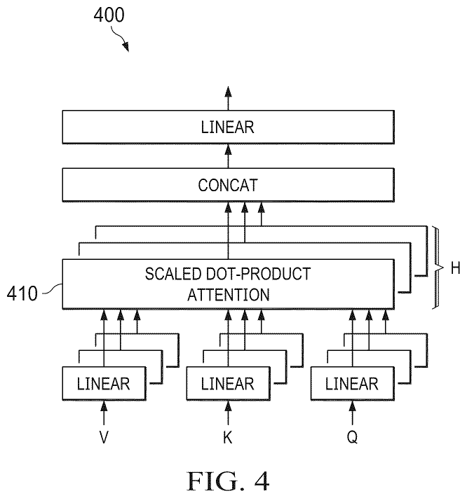

FIG. 4 illustrates an example multi-head attention model 400, according to some embodiments of the present disclosure. In some embodiments, the multi-head attention models 400 in sublayer 330 may be described as mapping a query and a set of key-value pairs to an output, where the query, keys, values, and output are all vectors. The output may be a weighted sum of the values, where the weight assigned to each value is computed by a compatibility function of the query with the corresponding key. In some embodiments, a single attention function with d_{model}-dimensional keys, values, and queries may be performed. However, in some embodiments, it may be preferable to linearly project the keys, values, and queries a certain number of times (i.e. h times) with different, learned linear projections to dₖ, dᵥ, and dₖ dimensions, respectively. On each projected version of keys, values, and queries, the attention function 410 may be performed in parallel, yielding dᵥ-dimensional output values. These values are concatenated and linearly projected to yield the final output from the multi-head attention model 400.

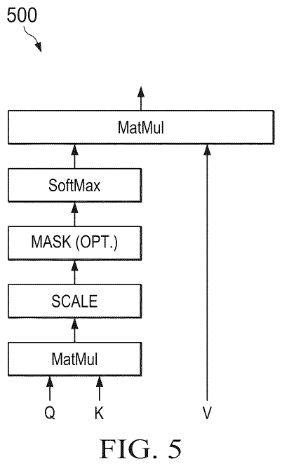

In some embodiments, the attention function 410 may be a scaled dot-product attention function 500. FIG. 5 illustrates an example of scaled dot-product attention 500, according to some embodiments of the present disclosure. The queries, keys, and values having dimensions dₖ, dₖ, and dᵥ, respectively, may be input into the scaled dot-product attention function 500. The dot product of the queries with all keys may be computed. The dot product may be scaled by dividing by \sqrt{dₖ} and a softmax function may be applied to obtain the weights on the values.

In some embodiments, the attention function 410 may be applied to a set of queries Q simultaneously, which may be packed together into a matrix Q. The keys and values may also be packed together into a matrices K and V, respectively.

In other embodiments, the attention function 410 may be an unscaled dot-product attention function or an additive attention function. However, the scaled dot-product attention function 500 may be preferable because it can be implemented using highly optimized matrix multiplication code, which may be faster and more space-efficient.

The output of the classifier 170 may be a classification 180 indicating the type of target feature detected. In cases where the medical video 130 is a colonoscopy video and the target feature is a polyp, the classifier 170 may analyze the target feature to determine if it is adenomatous or non-adenomatous. If the polyp is adenomatous, it may be likely to become cancer in the future and thus may need to be removed. If the polyp is non-adenomatous, the polyp may not need to be removed. The classification 180 may be in any appropriate form. For example, when classifying polyps, the classification 180 may be a textual representation of the type of polyp for example the word “adenomatous” or “non-adenomatous.” The textual representation may include a suggestion of how to handle the polyp. Thus, the textual representation may be “remove” or “leave.” The textual representation may also include the word “uncertain” to indicate that an accurate prediction was not generated.

In another example, the classification 180 may be a score indicating whether the target feature detected is a certain type or is not a certain type. When the target feature is a polyp, the score may indicate whether the polyp is adenomatous or non-adenomatous. The score may be a value in a range of 0 to 1, where 0 indicates the polyp is non-adenomatous and 1 indicates the polyp is adenomatous. Values closer to 0 indicate the polyp is more likely to be non-adenomatous and values closer to 1 indicate that the polyp is more likely to be adenomatous. In some embodiments, the score values may only include 0 and 1 and may not include a range between 0 and 1. In some embodiments, both a score and a textual representation may be output from the classifier 170. The textual representation may be based on a score, such that the score is compared to one or more threshold values to determine the textual representation. For example, if a score or value is less than a first threshold, the textual representation is one text string (e.g., “non-adenomatous”), and if a score or value is greater than a second threshold, the textual representation is a second text string (e.g., “adenomatous”), with the two thresholds between 0 and 1.

Although the above embodiments describe a target feature detector 140 being used in connection with the embedder 160 and the classifier 170, in some embodiments, the embedder 160 and classifier 170 may be implemented without the target feature detector 140. Instead, the embedder 160 may receive a set of frames including a target feature that were detected in any appropriate way. For instance, a physician may have identified frames that include a target feature and input only those frames into the embedder 160. In some cases, the embedder 160 receives the medical video 130 directly and not a subset of frames including the target feature.

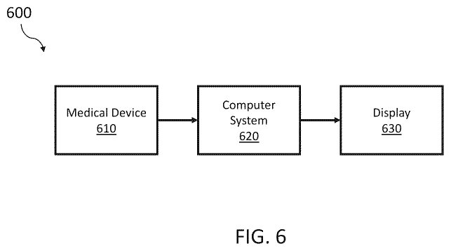

The disclosed method of implementing a target feature detector 140, an embedder 160, and a classifier 170 may be implemented using any appropriate hardware. For example, FIG. 6 shows a block diagram of a system 600 for implementing one or more of the methods described herein, according to some aspects of the present disclosure. The system 600 includes a medical device 610, a computer system 620, and a display 630. The medical device 610 may be any medical device capable of collecting a medical video 130. In some embodiments, the medical device 610 is an endoscope. The endoscope may be used during a colonoscopy to view the colon of a patient and collect a medical video 130. The target features in the colon may be, for example, polyps.

The medical video 130 collected by the medical device 610 may be sent to a computer system 620. In some embodiments, the medical device 610 may be coupled to the computer system 620 via a wire and the computer system 620 may receive the medical video 130 over the wire. In other cases, the medical device 610 may be separate from the computer system 620 and may be sent to the computer system 620 via a wireless network or wireless connection. The computer system 620 may be the computer system 100 shown and described in reference to FIG. 1. The computer system 620 may be a single computer or may be multiple computers.

The computer system 620 may include a processor-readable set of instructions that can implement any of the methods described herein. For example, the computer system 620 may include instructions including one or more of a target feature detector 140, an embedder 160, and a classifier 170, where the embedder 160 and classifier 170 may be implemented as a joint classification model 150.

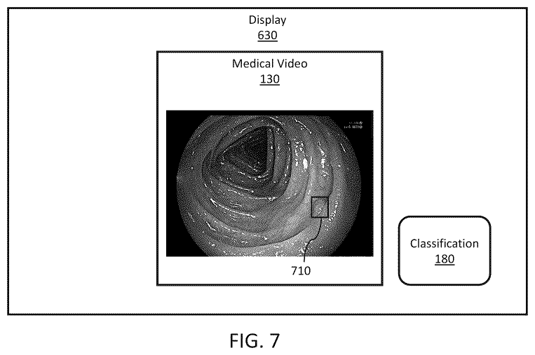

The computer system 620 may be coupled to a display 630. FIG. 7 illustrates an example display, according to some embodiments of the present disclosure. In the illustrated embodiment, the medical video 130 is a colonoscopy video collected from an endoscope and the target feature is a polyp. However, any suitable medical video 130 may be used and any target feature may be detected therein.

The computer system 620 may output the medical video 130 received from the medical device 610 to the display 630. In some cases, the medical device 610 may be coupled to or in communication with the display 630 such that the medical video 130 is output directly from the medical device 610 to the display 630.

A target feature detector 140 implemented on the computer system 620 may output a bounding box 710 identifying a location of a detected target feature. In some embodiments, the computer system 620 may combine the bounding box 710 and the medical video 130 and output the medical video 130 including the bounding box 710 to the display 630. Thus, the display 630 may show the medical video 130 with a bounding box 710 around a detected target feature so that the physician can see where a target feature may be located.

The target feature detector 140 may also output frames 210 including the target feature to the embedder 160 and the classifier 170, which may be implemented as a joint classification model 150. The joint classification model 150 may analyze the frames 210 to generate a classification 180 of the target feature, as described above. The classification 180 may be output to the display 630. As described above, the classification 180 may be in any appropriate form including a textual representation and/or a score. When the classification 180 is displayed, the classification 180 may be different colors depending on the type of target feature. For example, when the target feature is a polyp, the classification 180 may be green if the polyp is likely non-adenomatous and may be red if the polyp is likely adenomatous. A sound may play when a classification 180 is made or when the type of target feature may require action on the part of the physician. For example, if the polyp is likely adenomatous and should be removed, a sound may play so that the physician knows that she may need to resect the polyp.

In some embodiments, the medical video 130 collected by the medical device 610 may be sent to the computer system 620 as it is collected. In other words, the medical video 130 analyzed by the computer system 620 and displayed on the display 630 may be a live medical video 130 taken during the medical procedure. Thus, the classification 180 can be generated and displayed in real-time so that the physician can view the information during the procedure and make decisions about treatment if necessary. In other embodiments, the medical video 130 is recorded by the medical device 610 and sent to or analyzed by the computer system 620 after the procedure is complete. Thus, the physician can review the classifications 180 generated at a later time. In some cases, the medical video 130 can be displayed and analyzed in real-time and can be stored for later viewing.

The target feature detector 140, the embedder 160, and classifier 170 may be trained in any suitable way. As described above, the embedder 160 and classifier 170 may be implemented as a joint classification model 150 such that the embedder 160 and classifier 170 are jointly trained. However, the embedder 160 and classifier 170 may not be a joint classification model 150 and may instead be trained individually. In some embodiments, the embedder 160 may be jointly trained with the target feature detector 140. In some embodiments, the medical video 130 may be input into the embedder 160 before it is input into the target feature detector 140. The embedder 160 may then generate embedding vectors 220 for each frame of the medical video 130. The target feature detector 140 may then receive embedding vectors 220 and detect target features therein.

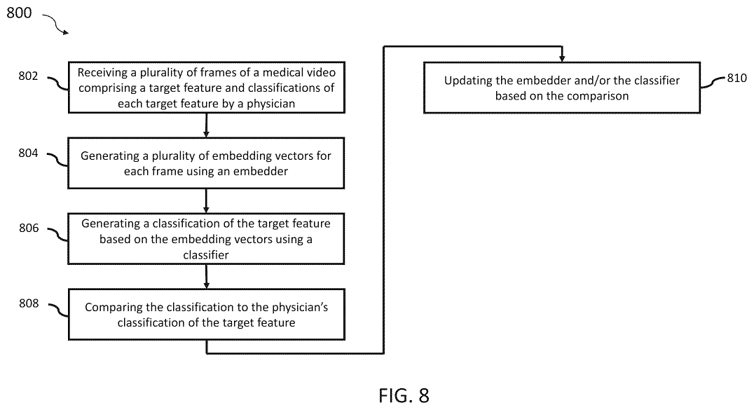

FIG. 8 is a flow diagram illustrating a method 800 of training the models, according to some aspects of the present disclosure. In the illustrated embodiment, the embedder 160 and the classifier 170 are implemented as a joint classification model 150 and, thus, are trained jointly. In the embodiments described herein, the target feature detector 140 is trained separately according to any suitable process known in the art. However, it is contemplated that the target feature detector 140 may be trained jointly with one or both of the embedder 160 or the classifier 170. In other cases, a target feature detector 140 may not be implemented with the embedder 160 and classifier 170.

Step 802 of the method 800 includes receiving a plurality of frames 210 of a medical video 130 comprising a target feature and classifications of each target feature by a physician. In some embodiments, the medical video 130 is a colonoscopy video and the target feature is a polyp. Thus, the physician classifying the polyp may be a gastroenterologist. In these cases, the gastroenterologist classifies the polyps as adenomatous and non-adenomatous based on a visual inspection of the medical video 130. The gastroenterologist may also classify the polyp based on whether she would remove or leave the polyp. When a gastroenterologist classifies the polyp, the classification may not be a diagnosis. Instead, it may be a classification indicating the likelihood that the polyp is a certain type and whether the gastroenterologist determines that the polyp should be removed.

In some embodiments, the physician classifying the target feature in a medical video is a pathologist. In this case, the classification of the target feature is a diagnosis of that target feature. In some cases, the pathologist may classify the target feature based on a visual inspection of the medical video 130. In other cases, the pathologist may receive a biopsy of the target feature in the medical video 130 and classify the target feature based on the biopsy. Thus, in cases where the target feature is a polyp, the pathologist may analyze the biopsy to diagnose the polyp in the colonoscopy video as adenomatous or non-adenomatous.

Step 804 of the method 800 may include generating an embedding vector 220 for each frame 210 of the medical video 130 using an embedder 160. As described above, the embedder 160 of the joint classification model 150 may receive the frames 210 and generate embedding vectors 220, where each embedding vector 220 is a computer-readable representation of the corresponding frame 210.

Step 806 of the method 800 may include generating a classification 180 of the target feature based on the embedding vectors 220 using a classifier 170. As described above, the classifier 170 may jointly analyze the embedding vectors 220 to generate a single classification 180 for the target feature in the frames 210. The classifier 170 may be implemented in any suitable way and the classification 180 may be in any suitable form, as described above.

Step 808 of the method 800 may include comparing the classification 180 to the physician's classification of the target feature. The classification 180 may be a textual representation of the target feature indicating the type. For example, when the target feature is a polyp, the classification may be “adenomatous” or “non-adenomatous.” In the training data, the physician may indicate whether the polyp is adenomatous or non-adenomatous. Thus, the classification 180 of the target feature is the same classification as the physician or a different classification. The accuracy of the classification may include calculating the percentage of correct scores. In cases where the target feature is a polyp, the positive probability value (PPV) may be calculated, which corresponds to the error in classifying a polyp as adenomatous when the physician classified the polyp as non-adenomatous. The negative probability value (NPV) may be calculated, corresponding to classifying a polyp as non-adenomatous when the physician classified the polyp as adenomatous.

In some embodiments, the classification 180 may be a score indicating the likelihood that a target feature is one type or another. As described above, for cases where the target feature is a polyp, the polyp may be given a score in a range of 0 to 1 by the classifier 170. A score of 1 may indicate the polyp is adenomatous and a score of 0 may indicate the polyp is non-adenomatous. In some embodiments, the Area Under the Receiver Operating Characteristic Curve (ROC AUC or AUC) may be calculated. The PPV and NPV may also be calculated for the scores generated by the classifier 170. In some cases, the training data may include a note of the likelihood the physician would score the polyp on a scale of 0 to 1. Thus, the score generated by the classifier 170 can be compared to the numerical value determined by the physician. However, in other cases, the training data may simply indicate whether the polyp is adenomatous (1) or non-adenomatous (0). Thus, the score may be compared to this classification in several suitable ways. For example, the score can be marked as correct if the score is closer to the correct value than the incorrect value. In other words, if a physician marks the polyp as adenomatous and the score is 0.7, the classification 180 is viewed as correct because it is above 0.5. On the other hand, if a physician marks the polyp as non-adenomatous and the score is 0.7, the classification 180 is viewed as incorrect because it is not below 0.5. Thus, the error can be calculated similarly to if the classification 180 by the classifier 170 is not based on a score. In other embodiments, the error may be calculated based on how far the score was from a perfect score. For example, if a physician marks the polyp as adenomatous and the score is 0.7, the classification 180 is as being off by 0.3 because the correct score is a 1. On the other hand, if a physician marks the polyp as adenomatous and the score is 0.9, the classification 180 is viewed as being off by 0.1. In other words, the error may be calculated based on the difference between the score and the correct classification.

Step 810 of the method 800 includes updating the embedder 160 and the classifier 170 based on the comparison. The joint classification model 150, including the embedder 160 and the classifier 170, may then be updated in any suitable way to generate a classification 180 that approaches the classification by the physician. In some embodiments, the joint classification model 150 may be updated based on one or more of the error, accuracy, AUC, PPV, or NPV. Step 810 may be based on gradient based optimization to decrease the error, such as the one described in Kingma et al., Adam: A Method for Stochastic Optimization, arXiv: 1412.6980 (Jan. 30, 2017), the entirety of which is incorporated herein by reference. However, other optimization methods can be used.

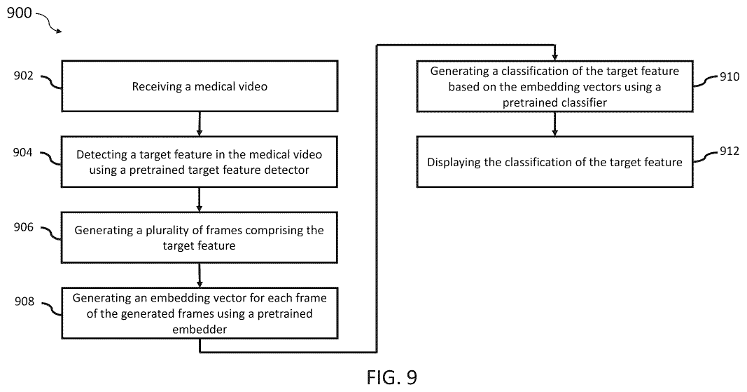

FIG. 9 is a flow diagram illustrating a method of operating a target feature detector 140, an embedder 160, and a classifier 170 during the inference stage. Step 902 includes receiving a medical video 130. As described above, the medical video 130 may be any suitable medical video and may include one or more target features. In some embodiments, the medical video 130 may be a colonoscopy video collected from an endoscope and the target feature may be a polyp.

Step 904 of method 900 may include detecting a target feature in the medical video 130 using a pretrained target feature detector 140. The pretrained target feature detector 140 may receive the medical video 130 and detect the target features therein and may be implemented in any suitable way, as described above.

Step 906 of the method 900 may include generating a plurality of frames 210 comprising the target feature. As described above, the target feature detector 140 may generate a series of frames 210 that include the target feature. These frames 210 may include all of the medical video 130 or only some frames of the medical video 130 and may be the same size as the frames of the medical video 130 or may be a smaller size.

Step 908 of the method 900 may include generating an embedding vector 220 for each frame of the generated frames 210 using a pretrained embedder 160. As described above, the embedder 160 of the joint classification model 150 may receive the frames 210 and generate embedding vectors 220, where each embedding vector 220 is a computer-readable representation of the corresponding frame 210. The embedder 160 may be trained in any suitable way, including the embodiments described in reference to FIG. 8.

Step 910 of the method 900 may include generating a classification 180 of the target feature based on the embedding vectors 220 using a pretrained classifier 170. As described above, the classifier 170 may jointly analyze the embedding vectors 220 to generate a single classification 180 for the target feature in the frames 210. The classifier 170 may be implemented in any suitable way and the classification 180 may be in any suitable form, as described above.

Step 912 of the method 900 may include displaying the classification 180 of the target feature. The classification 180 may be displayed on a display 630 in any suitable way, as described above.

An experiment was conducted in which a joint classification model was implemented according to some embodiments of the present disclosure and three aggregation models were implemented according to different prior art schemes. All models were used to classify polyps in frames of colonoscopy videos. All models output a score in a range of 0 to 1, where 0 indicates the polyp is non-adenomatous and 1 indicates the polyp is adenomatous.

As described above, the joint classification model includes an embedder and a classifier, which are jointly trained. The classifier jointly analyzes the frames including the target feature to generate a single classification. The aggregation models generate a score for each frame individually, then aggregate the scores to calculate an overall classification score. The aggregation for the aggregation models was conducted in three different ways. First, the mean score aggregation model aggregates the classifications by calculating the mean value of the classifications. Second, the maximum score aggregation model aggregates the classifications by using the maximum score of the classifications as the overall classification score. Third, the minority voting aggregation model aggregates the classifications by minority voting.

In some embodiments, the aggregation models may use the same base embedder and classifiers as the joint classification model. However, for the aggregation models, the classifier classifies each frame individually unlike for the joint classification models where all frames are classified jointly.

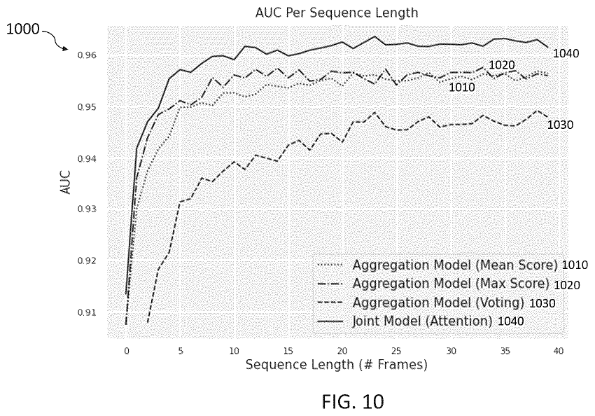

FIGS. 10-12 show various graphs and charts comparing the performance of the joint classification model to the three different aggregation models.

FIG. 10 is a graph 1000 of the AUC versus the number of frames (or sequence length) for each model. As shown, the joint classification model 1040 has a higher AUC than any of the aggregation models 1010, 1020, 1030 for all numbers of frames. The minority voting aggregation model 1030 has the lowest AUC for all number of frames. The max score aggregation model 1020 has a slightly higher AUC than the mean score aggregation model 1010. Thus, none of the aggregation models 1010, 1020, 1030 perform as well as the joint classification model 1040.

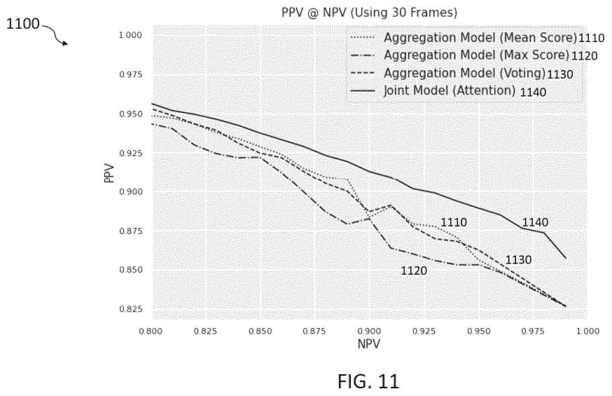

FIG. 11 is a graph 1100 of the PPV versus the PPV for each model. The mean score aggregation model 1110 and the minority voting aggregation model 1130 have similarly PPV values across NPV values. The maximum score aggregation model 1120 has slightly lower PPV values across NPV values than the other aggregation models 1110, 1130. The PPV of the joint classification model 1140 is higher for all NPV values as compared to the three aggregation models 1110, 1120, 1130. In particular, at high NPV values, the joint classification model 1140 significantly outperforms the aggregation models 1110, 1120, 1130. This indicates that the joint classification model is particularly better at predicting that the polyp is non-adenomatous and is unlikely to develop cancer if left in the colon.

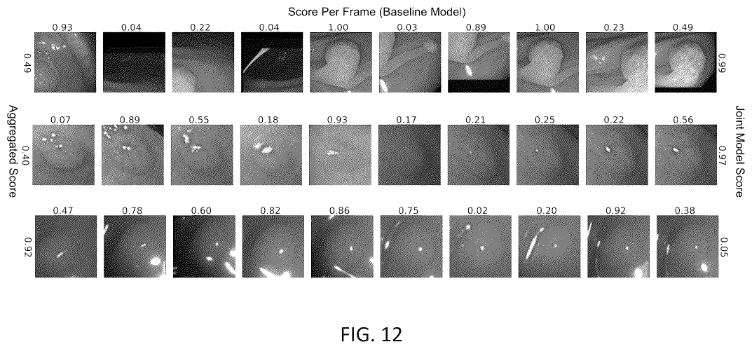

FIG. 12 is a chart illustrating why the joint classification model is better able to classify polyps. Each row of photos contains 10 frames of a colonoscopy video including a polyp in at least one frame. The score above each frame is a score calculated by the base model for the individual frame below it. The scores of the individual frames were aggregated and the aggregated score is shown on the left of the row. For the top row and the middle row, the individual scores were aggregated according to mean score aggregation. For the bottom row, the individual scores were aggregated by maximum score aggregation. The joint classification model score for the frames in the row is shown on the right of the row. The joint classification score is generated by jointly analyzing all frames in the row, as described herein. For the top row and the middle row, the joint classification score correctly classified the polyp as adenomatous and the aggregated score incorrectly classified the polyp as non-adenomatous. For the bottom row, the joint classification score correctly classified the polyp as non-adenomatous and the aggregated score incorrectly classified the polyp as adenomatous. Because the joint classification model compares the frames to each other, the joint classification model may give a lower weight to lower-quality or outlier frames that yield a less accurate result. On the other hand, the aggregation models may not identify the lower-quality or outlier frames and may weight these equally to higher-quality frames when aggregating the values. Thus, the joint classification model may generate a more accurate classification than aggregation models.

A number of variations are possible on the examples and embodiments described above. Accordingly, the logical operations making up the embodiments of the technology described herein are referred to variously as operations, steps, objects, elements, components, layers, modules, or otherwise. Furthermore, it should be understood that these may occur in any order, unless explicitly claimed otherwise or a specific order is inherently necessitated by the claim language.

Generally, any creation, storage, processing, and/or exchange of user data associated with the method, apparatus, and/or system disclosed herein is configured to comply with a variety of privacy settings and security protocols and prevailing data regulations, consistent with treating confidentiality and integrity of user data as an important matter. For example, the apparatus and/or the system may include a module that implements information security controls to comply with a number of standards and/or other agreements. In some embodiments, the module receives a privacy setting selection from the user and implements controls to comply with the selected privacy setting. In some embodiments, the module identifies data that is considered sensitive, encrypts data according to any appropriate and well-known method in the art, replaces sensitive data with codes to pseudonymize the data, and otherwise ensures compliance with selected privacy settings and data security requirements and regulations.

In several example embodiments, the elements and teachings of the various illustrative example embodiments may be combined in whole or in part in some or all of the illustrative example embodiments. In addition, one or more of the elements and teachings of the various illustrative example embodiments may be omitted, at least in part, and/or combined, at least in part, with one or more of the other elements and teachings of the various illustrative embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above. Connection references, such as “attached,” “coupled,” “connected,” and “joined” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” Unless otherwise noted in the claims, stated values shall be interpreted as illustrative only and shall not be taken to be limiting.

Additionally, the phrase “at least one of A and B” should be understood to mean “A, B, or both A and B.” The phrase “one or more of the following: A, B, and C” should be understood to mean “A, B, C, A and B, B and C, A and C, or all three of A, B, and C.” The phrase “one or more of A, B, and C” should be understood to mean “A, B, C, A and B, B and C, A and C, or all three of A, B, and C.”

Although several example embodiments have been described in detail above, the embodiments described are examples only and are not limiting, and those skilled in the art will readily appreciate that many other modifications, changes, and/or substitutions are possible in the example embodiments without materially departing from the novel teachings and advantages of the present disclosure. Accordingly, all such modifications, changes, and/or substitutions are intended to be included within the scope of this disclosure as defined in the following claims.

What is claimed is:

1. A method of classifying a target feature in a medical video by one or more computer systems, wherein the one or more computer systems comprises a first pretrained machine learning model and a second pretrained learning model, the method comprising:
receiving a plurality of frames of the medical video, wherein the plurality of frames comprises the target feature;
generating, by the first pretrained machine learning model, an embedding vector for each frame of the plurality of frames, each embedding vector having a predetermined number of values; and,
generating, by the second pretrained machine learning model, a classification of the target feature using the plurality of embedding vectors, wherein the second pretrained machine learning model analyzes the plurality of embedding vectors jointly.

2. The method of claim 1, wherein the first pretrained learning model comprises a convolutional neural network, and wherein the second pretrained machine learning model comprises a transformer.

3. The method of claim 1, wherein the classification comprises a score, wherein the score is in a range of 0 to 1.

4. The method of claim 1, wherein the classification comprises one of: positive, negative, or uncertain.

5. The method of claim 1, wherein the classification comprises a textual representation.

6. The method of claim 1, wherein the first pretrained machine learning model and the second pretrained machine learning model are jointly trained.

7. The method of claim 1, wherein the first pretrained machine learning model and the second pretrained machine learning model are trained separately.

8. The method of claim 1, wherein the medical video is collected during a colonoscopy procedure using an endoscope and wherein the target feature is a polyp.

9. The method of claim 8, wherein the classification comprises one of: adenomatous and non-adenomatous.

10. The method of claim 1, wherein the second pretrained machine learning model analyzes the plurality of embedding vectors without classifying each embedding vector individually.

11. A system for classifying a target feature in a medical video comprising:
an input interface configured to receive a medical video;
a memory configured to store a plurality of processor-executable instructions, the memory including:
an embedder based on a first pretrained machine learning model; and,
a classifier based on a second pretrained machine learning model; and,
a processor configured to execute the plurality of processor-executable instruction to perform operations including:
receiving a plurality of frames of the medical video, wherein the plurality of frames comprises the target feature;
generating, with the embedder, an embedding vector for each frame of the plurality of frames, each embedding vector having a predetermined number of values; and,
generating, with the classifier, a classification of the target feature using the plurality of embedding vectors, wherein the classifier analyzes the plurality of embedding vectors jointly.

12. The system of claim 11, wherein the first pretrained machine learning model comprises a convolutional neural network and the second pretrained machine learning model comprises a transformer.

13. The system of claim 11, wherein the classification comprises a score, wherein the score is in a range of 0 to 1.

14. The system of claim 11, wherein the classification comprises one of: positive, negative, or uncertain.

15. The system of claim 14, wherein the classification comprises a textual representation.

16. A non-transitory processor-readable storage medium storing a plurality of processor-executable instructions for classifying a target feature in a medical video, the instructions being executed by a processor to perform operations comprising:
receiving a plurality of frames of the medical video, wherein the plurality of frames comprises the target feature;
generating, by a first pretrained machine learning model, an embedding vector for each frame of the plurality of frames, each embedding vector having a predetermined number of values; and,
generating, by a second pretrained machine learning model, a classification of the target feature using the plurality of embedding vectors, wherein the second pretrained machine learning model analyzes the plurality of embedding vectors jointly.

17. The non-transitory processor-readable storage medium of claim 16, wherein the first pretrained machine learning model comprises a convolutional neural network and the second pretrained machine learning model comprises a transformer.

18. The non-transitory processor-readable storage medium of claim 16, wherein the classification comprises a score, wherein the score is in a range of 0 to 1.

19. The non-transitory processor-readable storage medium of claim 16, wherein the classification comprises one of: positive, negative, or uncertain.

20. The non-transitory processor-readable storage medium of claim 19, wherein the classification comprises a textual representation.
